(19) United States
(12) Patent Application Publication
(10) Pub. No.: US 2009/0094046 A1
(43) Pub. Date: Apr. 9, 2009

(54) Event-Recording Gift Container and Methods of Use

(75) Inventors: Richard A. Hyman, Boca Raton, FL (US); David Hyman, Orlando, FL (US); Matthew Goldstein, Boynton Beach, FL (US)

Correspondence Address: Oppedahl Patent Law Firm LLC, P.O. BOX 4850, FRISCO, CO, 80443-4850, US

(73) Assignee: Richard A. Hyman, Boca Raton, FL (US)

(21) Appl. No.: 12/027,974

(22) Filed: Feb. 7, 2008

Related U.S. Application Data
(60) Provisional application No. 60/977,656, filed on Oct. 5, 2007.

(51) Int. Cl. G06Q 99/00

(52) U.S. Cl. 705/1

(57) ABSTRACT

A means and methods are provided to give a gift and simultaneously and unobtrusively record images and/or sound to capture the emotion and excitement of the gift recipient upon receipt of the gift and discovery of the gift-container contents. A gift container is combined with miniaturized video and/or audio recording technologies for use in conjunction with microelectronics and provides a means for recorded data transfer to external devices. Appropriate methods associated with related rentals, sales, and services to the consumer using the gift container are provided.

### CROSS-REFERENCE TO OTHER APPLICATIONS

This application claims priority from U.S. application No. 60/977,656, filed Oct. 5, 2007, which application is incorporated herein by reference for all purposes.

### BACKGROUND

Often, some of the most memorable moments and milestone events in people's lives coincide with gift giving, particularly in large luxury goods industries such as the jewelry industry. In the past, a typical monumental gift (e.g., engagement ring, 10^{th} anniversary gift, 50^{th} birthday gift, etc.) involved two processes: (1) Receiving the gift, and (2) Sometimes someone having a camera available to take photographs or video recordings after the gift was opened and received. Moreover, most if not all spontaneity is lost when trying to capture the moment of gift receiving and the reaction of the gift recipient if cameras are obviously present to record the event during or after the gift giving.

If available, the photographs or video that might be treasured for years can only capture the emotions and excitement after the gift is discovered—perhaps a significant period of time while someone finds an available camera. Ideally, the excitement and emotions of a gift recipient should be captured during the actual gift-giving event without first tipping off the gift recipient vis-à-vis obvious cameras pointing at the recipient.

The lack of the convenient and effective capability to capture such treasured moments in a candid way also points to a market opportunity for jewelers and other types of vendors whose chattels are often suited for special gifts. Making such an opportunity, including related ancillary services, available to consumers may well enhance consumer satisfaction and allegiance to the vendor.

Of course, a gift box is a well-known item as is a still or motion picture camera. However, the two items are not combined in any known art such that the actual moment of gift transfer and recipient realization are captured, including all of the emotion, surprise, gratitude, and excitement that goes along with the receipt of a special gift.

Accordingly, a melding of the two basic gift-giving processes cited above is desired to turn a routine gift-giving into a “media event,” while allowing the gift-giver to control the moment when the process starts to record the rare emotion at the actual moment of inception, which can later be enjoyed and shared forever.

Many gifts have emotional value far beyond their financial cost. Whether it is an engagement ring, a necklace, the keys to a car, a favorite bottle of wine, or a bottle of shaving lotion or perfume, many consumers would like to be able to have a convenient way to record their special moment. The need and desire for such a solution is so widespread that it could eventually be a factor in any competitor's ability to make a sale if they did not offer this capability.

### BRIEF DESCRIPTION OF THE DRAWINGS

FIG. 1 provides a front view from a slightly upper angle of one embodiment of the invention, a typical jewelry-gift-box application.

FIG. 2 provides an interior view of the lower portion of one embodiment of the invention, a typical jewelry-gift-box application.

FIG. 3 provides a top view of one embodiment of the invention, a typical jewelry-gift-box application.

FIG. 4 provides an interior view of the upper portion of one embodiment of the invention, a typical jewelry-gift-box application.

FIG. 5 provides a flow diagram for a method for presenting an event-recording gift container.

FIG. 6 provides a flow diagram for a method for renting an event-recording gift container.

FIG. 7 provides a flow diagram for a method for selling an event-recording gift container.

FIG. 8 provides a flow diagram for a method for selling an event-recording gift container with added consumer services.

FIG. 9 provides a flow diagram for a method for renting an event-recording gift container with supporting equipment.

FIG. 10 provides a flow diagram for a method for selling an event-recording gift container with supporting equipment.

### BRIEF SUMMARY OF THE INVENTION

The invention is the next step for jewelry companies and other companies that make or sell gift items to be able to offer their buyers a new and special way to capture the special moment and the history of the gift-giving event. Countless gifts are given every day throughout the world where the people involved are left to wish that they had a “great picture of the moment.”

The invention provides a means to give a gift and simultaneously and record images and/or sound in a non-intrusive way, to capture the emotion and excitement of the gift recipient upon receipt of the gift and discovery of the gift-container contents. The invention uses technologies available today and blends them with gift packaging for the luxury goods retail market. In particular, it makes it possible for what appears to be a common gift to actually take still photographs and/or moving videos and/or audio recordings at the very moment the recipient of a gift begins opening the container until the gift recipient has actually discovered the contents inside the container.

The invention combines photographic technology and circuitry within the actual gift container itself. Additionally, the invention can have a sound-recording option for consumers interested in capturing audio sounds, including words and emotions.

The invention can begin recording events just before gift transfer to the recipient in order to fully capture the recipient's reactions upon initial receipt and subsequent opening of the gift container. In one version of the invention, the gift container has two cameras—one for capturing images before the gift container is opened, and a second located in the interior of the gift container to be activated as the gift container is opened and the recipient is looking inside. The length of time to be recorded can be varied, depending on the application and end-user needs. All cameras and audio recording devices are sufficiently small and stowed in the gift container to avoid immediate detection by the gift recipient and to minimize visual obstructions for taking images.

The invention can accommodate a variety of recorded data-storage and transfer strategies. Such options include USB ports, high-capacity memory cards, wireless transfer to an external computing device, and transfer to an internet host for retrieval online by whomever the consumer chooses.

### DETAILED DESCRIPTION

### First Embodiment

### Jewelry Gift Box

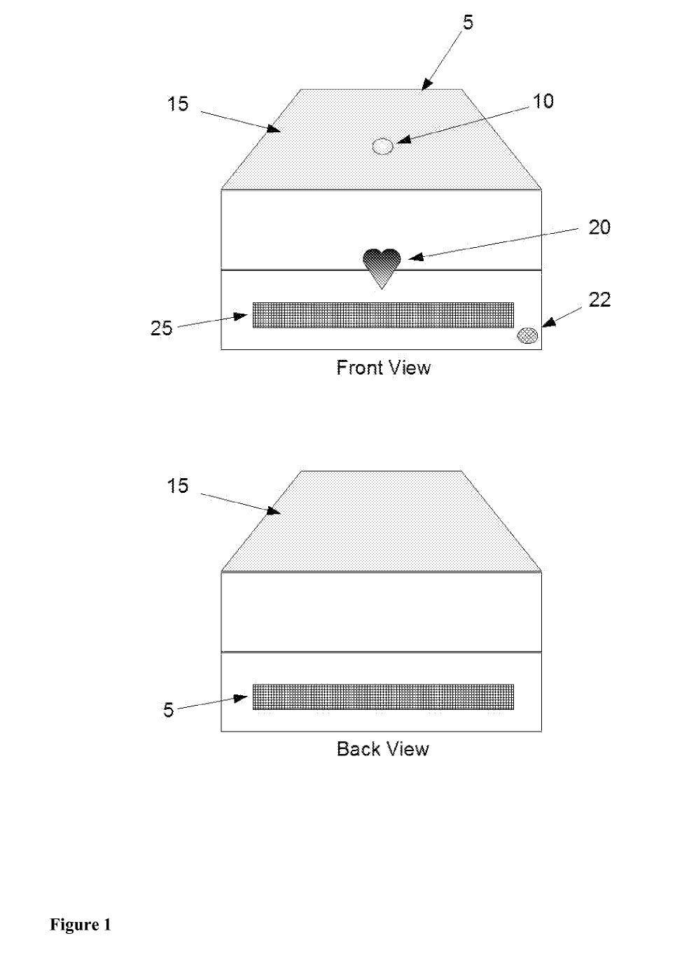

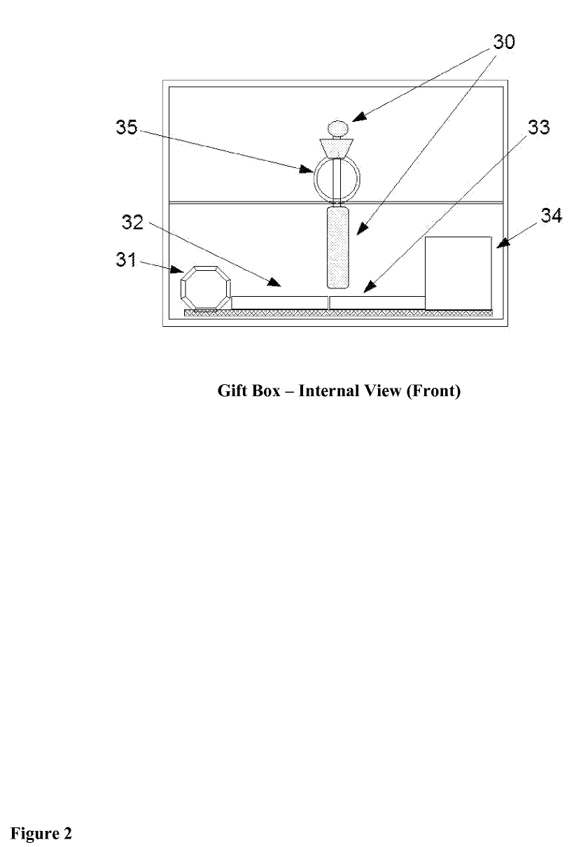

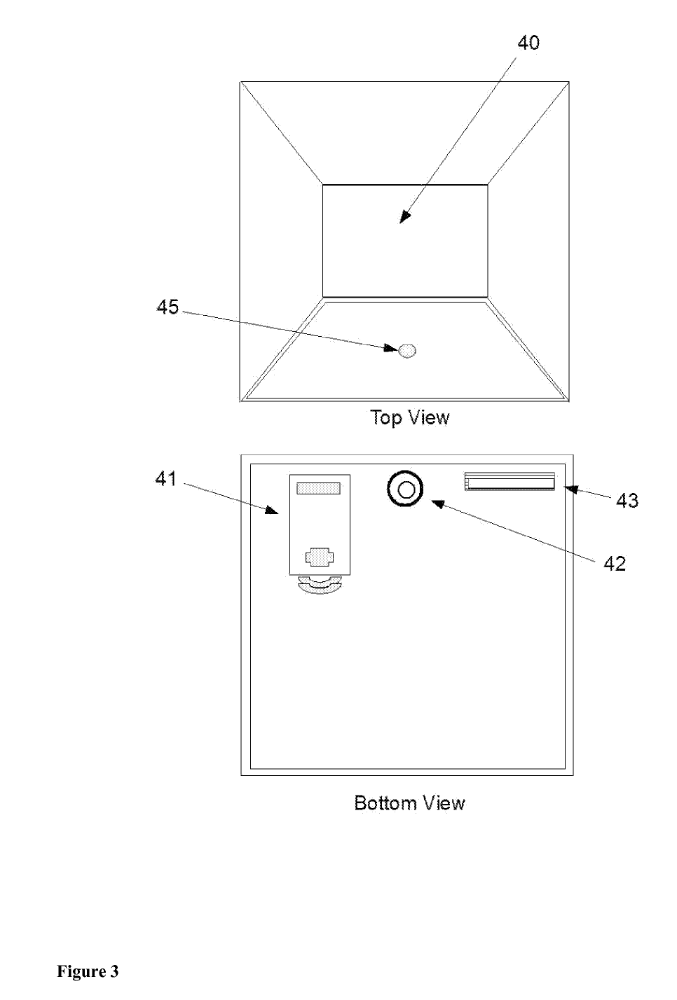

One embodiment of the invention incorporates the media-recording capabilities within a jewelry gift box, typically a small box suitable for giving a ring, bracelet, or necklace. Of course, the invention itself is not limited to such an application and can be applied to myriad types of gift containers and gift subject matter. FIGS. 1 through 4 are referred to as this embodiment is described. Said gift box uses at least one camera, but can also use a second camera as well as a miniature microphone for recording audio while still or motion video images are captured. The gift box has a power supply [FIG. 2: #31], [FIG. 3: #41, #42] to drive onboard electronics to facilitate the activation of video and/or audio recording and digital storage and/or transmittal of the captured video data and/or audio data. Ideally, the power supply is a small, rechargeable, onboard battery, with a recharging connection incorporated in the gift box [FIG. 3: #42]. The onboard electronics typically include a microchip as a control means [FIG. 2: #32], such as an application-specific integrated circuit (ASIC) and a memory card or stick [FIG. 2: #33] of sufficient capacity to provide non-volatile data storage of up to 10 minutes of captured streaming video and/or audio data. Obviously, the data-storage capacity can be varied according to a specific application. If the goal is to only capture a series of still images, then the data-storage capacity could be much smaller; for example, about 2 Gb of memory storage could hold well over 500 images of moderate, printable resolution.

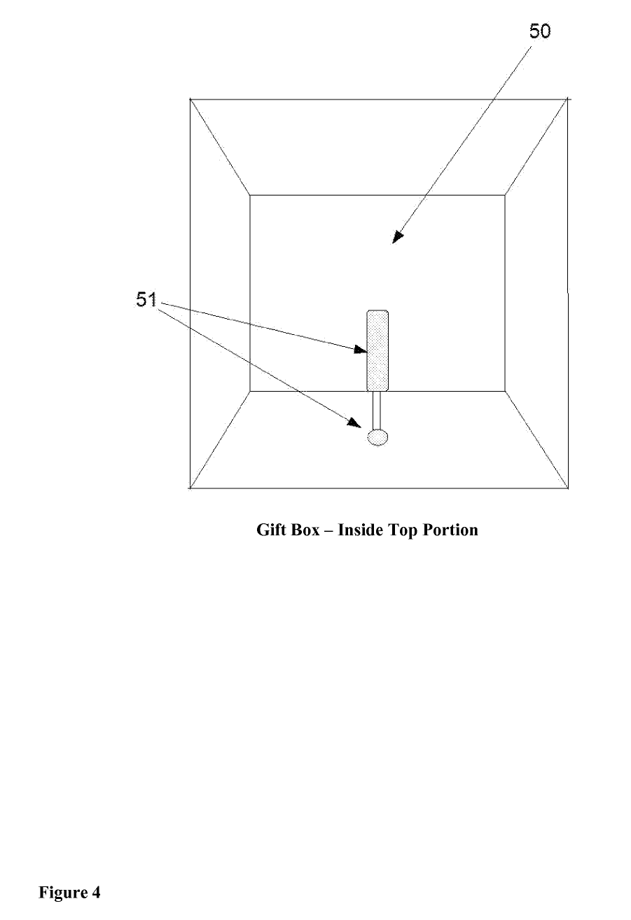

Optionally, the gift box has a first miniature camera [FIG. 1: #10], [FIG. 3: #45], [FIG. 4: #51] located such that its lens can capture streaming video and/or still pictures from the top of the still-closed jewelry gift box. Depending on the gift-box design, the lens could be located behind a clear material (such as glass or acrylic) [FIG. 3: #45] or can be left completely unobstructed, with the small lens being incorporated in the outer ornamental design to help hide the camera from the gift recipient.

The gift box has a miniature camera located within [FIG. 2: #30] and proximal to the mounting to the gift itself, and angled such that it would likely capture the facial expressions of the gift recipient upon the opening of the gift box and a recognition of the gift contained therein [FIG. 2: #35]. This internal miniature camera is not apparent to the gift recipient, and is also located in such a way as to minimize any visual obstructions for the camera (such as the gift itself).

The gift box also can optionally contain a miniature microphone for audio recording [FIG. 1: #22]. Said microphone is ideally located discretely on the outside front [as shown for example in FIG. 1] or on top of the gift box. There are many miniature microphone technologies available to employ for this purpose; for example, micro-electrical mechanical systems (MEMS) microphones or piezoelectric-type microphones.

The activation and shutdown of the camera(s) and microphone is typically controlled by the gift giver, who can activate the media recording by contacting an activation means on one or more sides of the outside of the gift box. This activation means can be an electro-mechanical means such as a reed switch or a push button actuator [FIG. 1: #20], or some other touch-enabled means (for example, capacitance sensors or conductive rubber) [FIG. 1: #25, #5] to send a signal to the control means {FIG. 2: #32], which in turn sends signals to the recording device(s) to activate and/or deactivate it (them). Preferably such a touch-enabled means is disguised by an attractive overlay of wood, metal, or material, designed to match the aesthetics of the originally designed box.

To facilitate the transfer of recorded data, the gift box is typically fitted with a USB port (or its functional equivalent as computing protocols evolve) [FIG. 2: #34], [FIG.3: #43] to allow the transfer of the captured data to an external computing or video-display device. In addition or alternatively, the gift box can be outfitted with wireless data-communications capabilities to allow the transfer of stored data to an external computing device, or even to bypass the data-storage needs of the gift box altogether and transfer real-time media data to an external computing or video-display device. Said wireless capabilities can include radio transmission and/or infrared light transmission.

The lower part of the gift box contains most of the supporting electronics, hidden underneath the mounting of the gift [FIG. 2: #35]. The upper-half of the gift box, however, is relatively large compared to the lower half of the gift box, is substantially void [FIG. 3: #40, FIG. 4: #40], and is designed to minimize video-recording obstructions as well as to help a gift recipient to glimpse the internal contents for applications that use clear material in at least part of the upper half of the gift box [FIG. 3: #45].

### Second Embodiment

### Method of Presenting a Gift

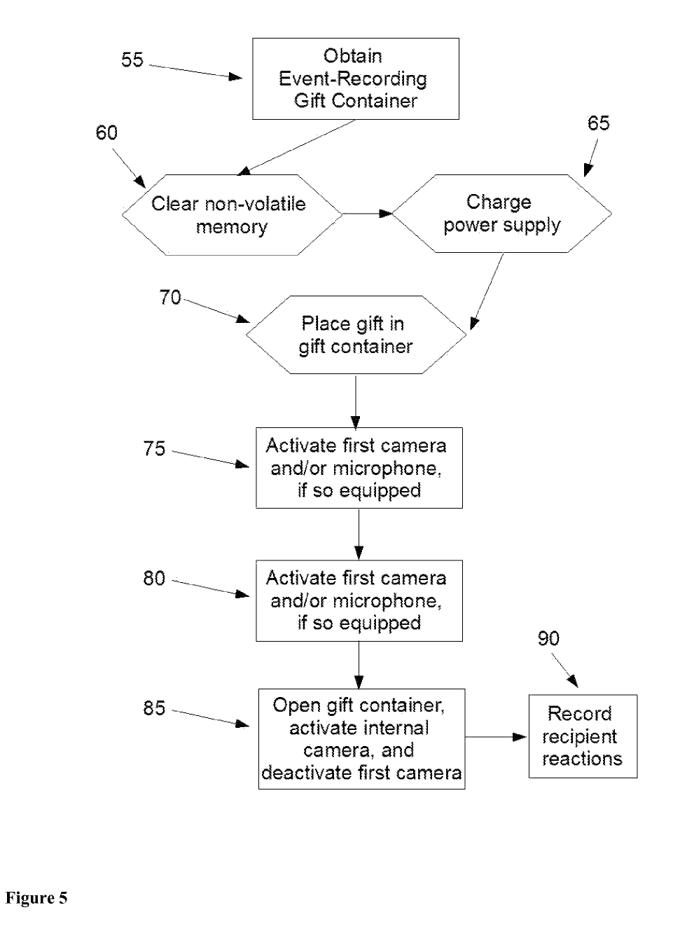

See FIG. 5. A gift is presented in a novel fashion using an event-recording gift container, similar to that described in the First Embodiment [FIGS. 1-4], [FIG. 5: #55]. After properly ensuring that the onboard memory is free for recording and the onboard power supply is available [FIG. 5: #60, #65], the gift giver places the gift inside the container, on its mount [FIG. 5: #70]. The gift giver starts to present the gift to the recipient by activating the first camera (if so equipped) and/or the microphone (if so equipped) using an electro-mechanical means or touch-enabled means [FIG. 5: #75]. The recording of the gift recipient's reactions start at this point. When the gift box is opened, the internal camera is activated [FIG. 5: #80], deactivating the first camera (if so equipped) [FIG. 5: #85], and the recipient's reactions are recorded as he or she views first views the gift [FIG. 5: #90].

### Third Embodiment

### Method of Renting a Gift Container for Presentation of Gifts

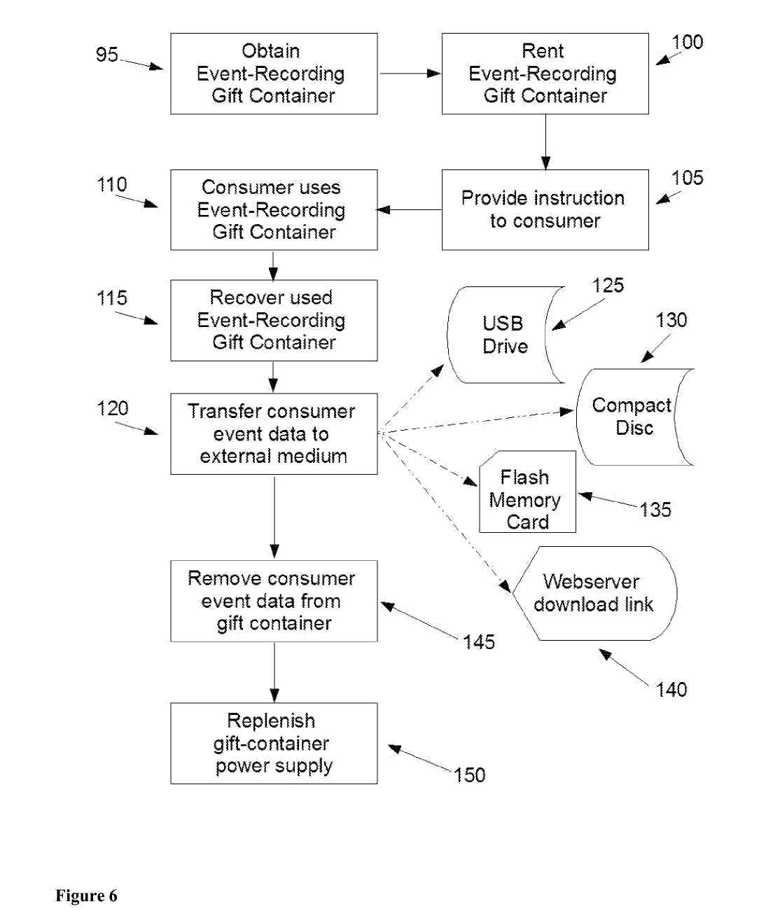

See FIG. 6. A vendor can take advantage of the invention by obtaining a gift container similar to that described in the First Embodiment above [FIG. 6: #95], then renting the gift container to a consumer [FIG. 6: #100], providing necessary instruction (oral, written, and/or demonstrative) on its use [FIG. 6: #105]. After said consumer uses the gift container according to the Second embodiment above [FIG. 6: #110], the vendor recovers the gift container from the consumer [FIG. 6: #1 15]. The vendor transfers recorded data from the gift container onto an external medium for the consumer's convenient access [FIG. 6: #120]. Said external medium can include a USB memory drive [FIG. 6: #125], a compact disc [FIG. 6: #130], a flash memory card [FIG. 6: #135], of an internet-based weblink [FIG. 6: #140] to for downloading recorded video, images, and/or audio. The recorded data is then removed from the gift container in preparation for the next consumer use [FIG. 6: #145]. If necessary, the onboard power supply is replenished; e.g., battery recharging or replacement [FIG. 6: #150].

### Fourth Embodiment

### Method of Selling a Gift Container for Presentation of Gifts

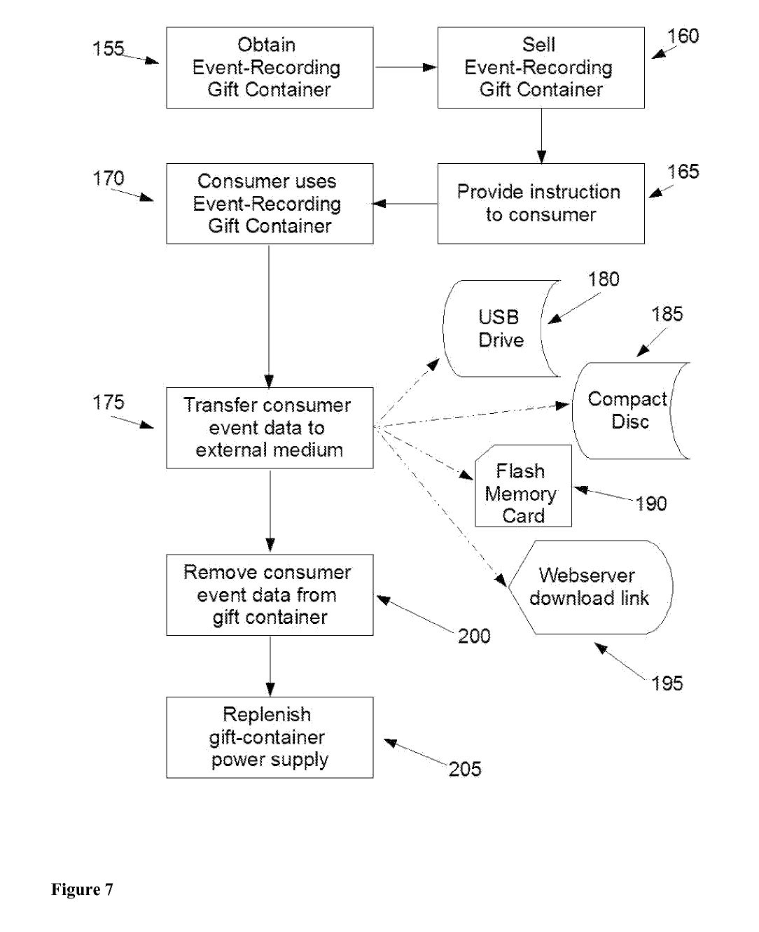

See FIG. 7. A vendor can take advantage of the invention by obtaining a gift container similar to that described in the First Embodiment above [FIG. 7: #155], then selling the gift container to a consumer [FIG. 7: #160] , providing necessary instruction (oral, written, and/or demonstrative) on its use [FIG. 7: #165]. After said consumer uses the gift container according to the Second embodiment above [FIG. 7: #170], the consumer transfers recorded data from the gift container onto an external medium for the consumer's convenient access [FIG. 7: #175]. Said external medium can include a USB memory drive [FIG. 7: #180], a compact disc [FIG. 7: #185], a flash memory card [FIG. 7: #190], of an internet-based weblink [FIG. 7: #195] to for downloading recorded video, images, and/or audio. The recorded data is then removed from the gift container in preparation for the next use [FIG. 7: #200]. If necessary, the onboard power supply is replenished; e.g., battery recharging or replacement [FIG. 7: #205].

### Fifth Embodiment

### Method of Selling a Gift Container With Added Consumer Services

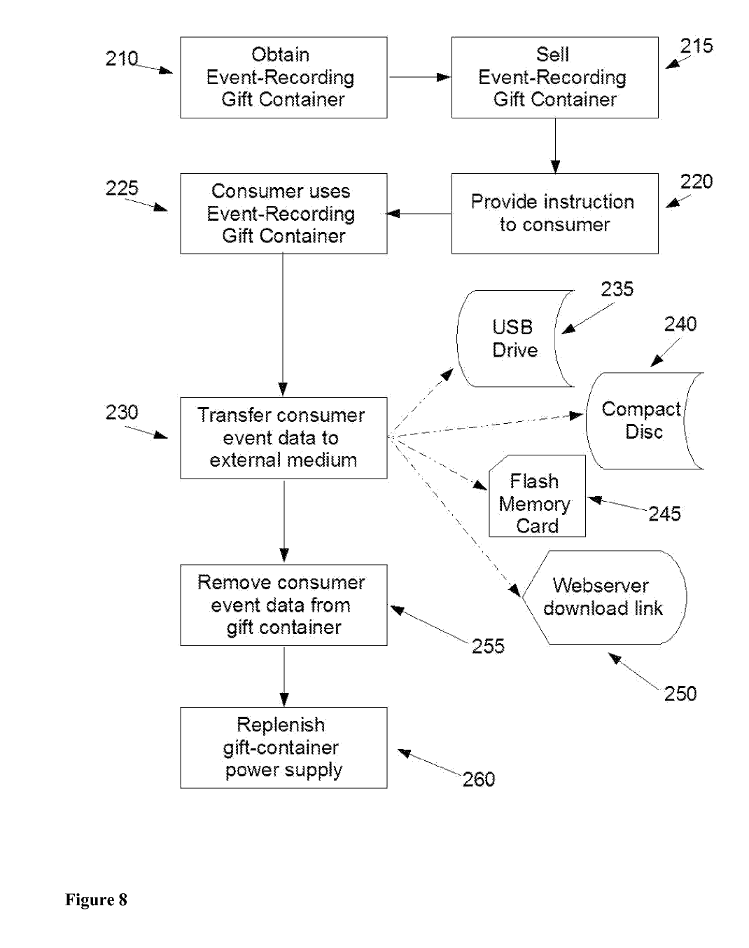

See FIG. 8. A vendor can take advantage of the invention by obtaining a gift container similar to that described in the First Embodiment above [FIG. 8: #210], then selling the gift container to a consumer [FIG. 8: #215] , providing necessary instruction (oral, written, and/or demonstrative) on its use [FIG. 8: #220]. After said consumer uses the gift container according to the Second embodiment above [FIG. 8: #225], the consumer brings the gift container to the vendor, who then transfers recorded data from the gift container onto an external medium for the consumer's convenient access [FIG. 8: #230]. Said external medium can include a USB memory drive [FIG. 8: #235], a compact disc [FIG. 8: #240], a flash memory card [FIG. 8: #245], of an internet-based weblink [FIG. 8: #250] to for downloading recorded video, images, and/or audio. The recorded data is then removed from the gift container in preparation for the next use [FIG. 8: #255]. If necessary, the onboard power supply is replenished; e.g., battery recharging or replacement [FIG. 8: #260].

### Sixth Embodiment

### Method of Renting a Gift Container With Support Equipment

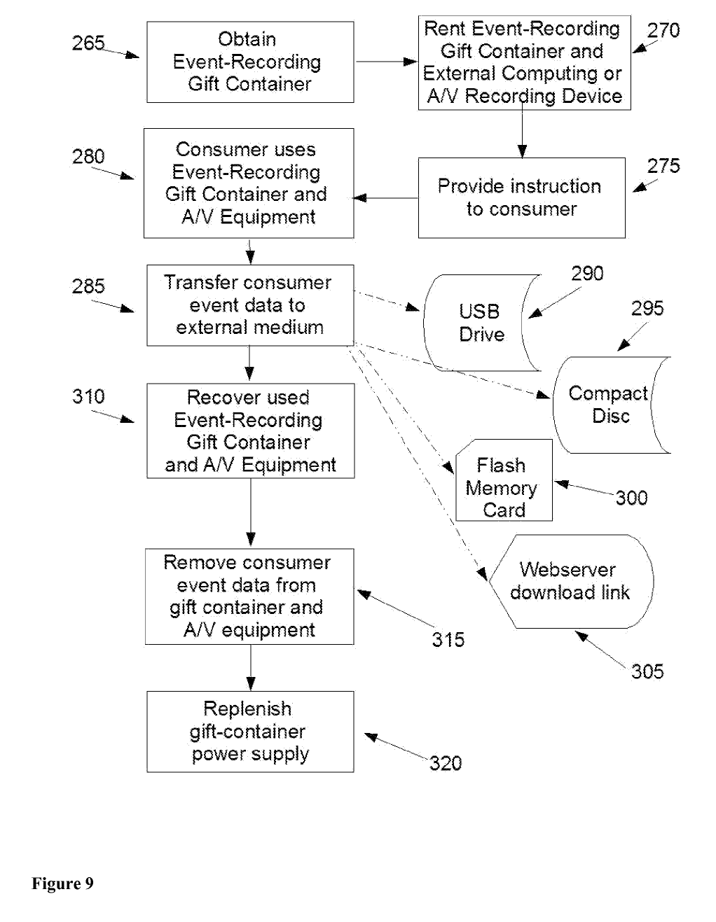

See FIG. 9. A vendor can take advantage of the invention by obtaining a gift container similar to that described in the First Embodiment above [FIG. 9: #265], then renting the gift container and an external computing and/or audio-video-recording device to a consumer [FIG. 9: #270], providing necessary instruction (oral, written, and/or demonstrative) on the use of the rented devices [FIG. 9: #275]. After said consumer uses the gift container according to the Second embodiment above [FIG. 9: #280], the consumer transfers recorded data from the gift container onto an external medium for the consumer's convenient access [FIG. 9: #285]. Said external medium can include a USB memory drive [FIG. 9: #290], a compact disc [FIG. 9: #295], a flash memory card [FIG. 9: #300], of an internet-based weblink [FIG. 9: #305] to for downloading recorded video, images, and/or audio. The vendor recovers the gift container from the consumer [FIG. 9: #3 10]. The recorded data is then removed from the gift container and from the external computing and/or audio-video-recording device in preparation for the next consumer use [FIG. 9: #315]. If necessary, the gift container's onboard power supply is replenished; e.g., battery recharging or replacement [FIG. 9: #320].

### Seventh Embodiment

### Method of Selling a Gift Container With Support Equipment

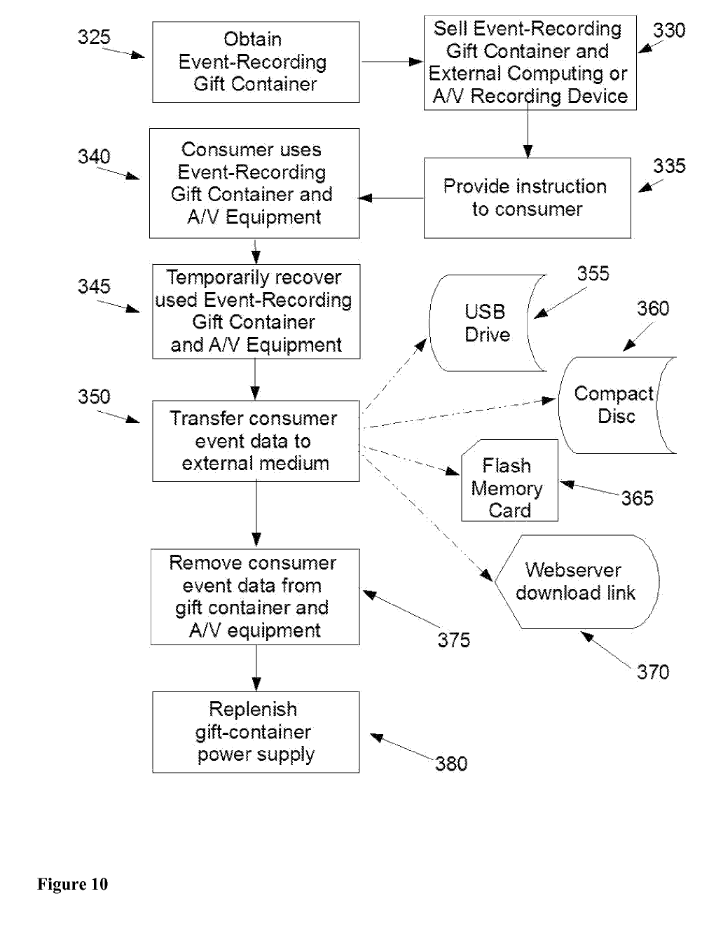

See FIG. 10. A vendor can take advantage of the invention by obtaining a gift container similar to that described in the First Embodiment above [FIG. 10: #325], then selling the gift container and an external computing and/or audio-video-recording device to a consumer [FIG. 10: #330], providing necessary instruction (oral, written, and/or demonstrative) on its use [FIG. 10: #335]. After said consumer uses the gift container according to the Second embodiment above [FIG. 10: #340], the consumer brings the gift container to the vendor [FIG. 10: #345], who then transfers recorded data from the gift container onto an external medium for the consumer's convenient access [FIG. 10: #350]. Said external medium can include a USB memory drive [FIG. 10: #355], a compact disc [FIG. 10: #360], a flash memory card [FIG. 10: #365], of an internet-based weblink [FIG. 10: #370] to for downloading recorded video, images, and/or audio. The recorded data is then removed from the gift container and from the external computing and/or audio-video-recording device in preparation for the next consumer use [FIG. 10: #375]. If necessary, the gift container's onboard power supply is replenished; e.g., battery recharging or replacement [FIG. 10: #380].

Those skilled in the art will have no difficulty devising myriad obvious variants and improvements of the invention, having been informed by the teachings of the present document. All such obvious variants and improvements are intended to be encompassed within the scope of the claims which follow.

What is claimed is:

1. A method for presenting a gift, comprising the steps of:
placing said gift inside a gift container, said gift container comprising:
an enclosure with a means to open said enclosure to display said enclosed gift,
wherein the volume and geometry in the top of said enclosure provides a substantial void around the enclosed gift to facilitate viewing of said gift and to facilitate minimal visual obstructions to camera viewing;
a control means for controlling signal and data-processing components;
a means for detecting the start of the gift-transfer process in order to send a signal to said control means to activate video-recording functionality;
an enclosure-opening sensing means,
wherein said enclosure-opening sensing means can be activated by either the gift giver or the gift recipient, and
wherein said enclosure-opening sensing means is communicatively coupled with said control means;
a means for non-volatile memory storage;
a power supply for all camera and data-processing components within said gift container;
a means for communicating recorded data with an external computing device or video-display device;
a first camera,
wherein said first camera lens is located in the top of said enclosure, is set such that said first camera lens' line of sight is substantially unobfuscated by other gift-container components and materials, is angled for optimum video recording or optimum still-picture taking of the gift recipient, and is not obvious to a casual observer, and
wherein said first camera is activated by said gift-transfer process detecting means, thus is able to record images via said control means and said non-volatile memory storage means; and
a second camera,
wherein said second camera lens is in a hidden position proximal to the setting position for the enclosed gift, but is substantially unobfuscated from viewing the opening of said enclosure by the gift recipient, and
wherein said second camera is activated by said enclosure-opening sensing means, thus is able to record images via said control means and said non-volatile memory storage means;
preparing to present said gift to the gift recipient by activating said gift-transfer process detecting means, thus activating said first camera;
giving said gift to the gift recipient while said first camera records video or still pictures to document the gift recipient's reactions; and
opening said gift container by the gift recipient or by the gift giver, thereby activating said enclosure-opening means and in turn activating said second camera and recording video or still pictures to document the gift recipient's reactions as said enclosed gift is viewed unobstructed.

2. The method of claim 1, wherein said first camera lens is set in clear material.

3. The method of claim 1, wherein said gift container further comprises a means to record audio, said audio-recording means being activated simultaneously with the activation of said first camera by said gift-transfer process detecting means, and is thus able to record audio via said control means and said non-volatile memory storage.

4. The method of claim 3, further comprising the step of recording audio to document a gift recipient's reactions and the audio environment as the gift is viewed.

5. The method of claim 1, wherein said means for detecting the start of the gift-transfer process is a touch-enabled sensor on the outside of said enclosure,
wherein said touch-enabled sensor can be activated by either the gift giver or the gift recipient, and
wherein said touch-enabled sensor is communicatively coupled with said control means.

6. The method of claim 5, wherein said touch-enabled sensor is a capacitance sensor located on at least one side of said gift container such that a signal to start said first camera recording occurs when said gift container is contacted by a thumb or a finger.

7. The method of claim 5, wherein said touch-enabled sensor is disguised by an attractive overlay of wood, metal, or material, designed to match the aesthetics of the originally designed gift container.

8. The method of claim 1, wherein said means for detecting the start of the gift-transfer process is a motion sensor incorporated in said gift container.

9. The method of claim 1, wherein said gift container's non-volatile memory storage is a removable flash memory card with an effective storage size for recording streaming video and audio.

10. The method of claim 9, wherein said effective storage size allows for recording up to 10 minutes of streaming video and audio.

11. The method of claim 9, wherein said gift container's a means for communicating recorded data with an external computing device or video-display device is to remove said flash memory card and install it into another computing device or video-display device for data reading and transfer.

12. The method of claim 1, wherein said gift container's a means for communicating recorded data with an external computing device or video-display device is a USB port.

13. The method of claim 1, wherein said gift container's a means for communicating recorded data with an external computing device or video-display device is a wireless data stream.

14. A method for providing a consumer with the ability to present a gift while recording the gift-recipient's reactions, comprising the steps of:
obtaining or manufacturing a gift container, said gift container comprising:
an enclosure with a means to open said enclosure to display said enclosed gift,
wherein the volume and geometry in the top of said enclosure provides a substantial void around the enclosed gift to facilitate viewing of said gift and to facilitate minimal visual obstructions to camera viewing;
a control means for controlling signal and data-processing components;
a means for detecting the start of the gift-transfer process in order to send a signal to said control means to activate video-recording functionality;
an enclosure-opening sensing means,
wherein said enclosure-opening sensing means can be activated by either the gift giver or the gift recipient, and
wherein said enclosure-opening sensing means is communicatively coupled with said control means;
a means for non-volatile memory storage;
a power supply for all camera and data-processing components within said gift container;
a means for communicating recorded data with an external computing device or video-display device;
a first camera,
wherein said first camera lens is located in the top of said enclosure, is set such that said first camera lens' line of sight is substantially unobfuscated by other gift-container components and materials, is angled for optimum video recording or optimum still-picture taking of the gift recipient, and is not obvious to a casual observer, and
wherein said first camera is activated by said gift-transfer process detecting means, thus is able to record images via said control means and said non-volatile memory storage means; and
a second camera,
wherein said second camera lens is in a hidden position proximal to the setting position for the enclosed gift, but is substantially unobfuscated from viewing the opening of said enclosure by the gift recipient, and
wherein said second camera is activated by said enclosure-opening sensing means, thus is able to record images via said control means and said non-volatile memory storage means;
renting said gift container to said consumer;
recovering said gift container from said consumer, after said consumer uses said gift container by:
preparing to present said gift to the gift recipient by activating said gift-transfer process detecting means, thus activating said first camera,
giving said gift to the gift recipient while said first camera records video or still pictures to document the gift recipient's reactions; and
opening said gift container by the gift recipient or by the gift giver, thereby activating said enclosure-opening means and in turn activating said second camera and recording video or still pictures to document the gift recipient's reactions as said enclosed gift is viewed unobstructed;
transferring recorded data from said gift container onto an external medium for said consumer's convenient access; and
removing recorded data from said gift container in preparation for the next gift-container rental.

15. The method of claim 14, further comprising the step of providing a consumer with instruction on the use of said gift container.

16. The method of claim 14, wherein said external medium for said consumer's convenient access is selected from the group consisting of a portable USB memory drive, a compact disc, and removable flash memory card.

17. The method of claim 14, wherein said external medium for said consumer's convenient access is a website link to download video, images, and audio to said consumer's computing device.

18. A method for providing a consumer with the ability to present a gift while recording the gift-recipient's reactions, comprising the steps of:
obtaining or manufacturing a gift container, said gift container comprising:
an enclosure with a means to open said enclosure to display said enclosed gift,
wherein the volume and geometry in the top of said enclosure provides a substantial void around the enclosed gift to facilitate viewing of said gift and to facilitate minimal visual obstructions to camera viewing;
a control means for controlling signal and data-processing components;
a means for detecting the start of the gift-transfer process in order to send a signal to said control means to activate video-recording functionality;
an enclosure-opening sensing means,
wherein said enclosure-opening sensing means can be activated by either the gift giver or the gift recipient, and
wherein said enclosure-opening sensing means is communicatively coupled with said control means;
a means for non-volatile memory storage;
a power supply for all camera and data-processing components within said gift container;
a means for communicating recorded data with an external computing device or video-display device;
a first camera,
wherein said first camera lens is located in the top of said enclosure, is set such that said first camera lens' line of sight is substantially unobfuscated by other gift-container components and materials, is angled for optimum video recording or optimum still-picture taking of the gift recipient, and is not obvious to a casual observer, and
wherein said first camera is activated by said gift-transfer process detecting means, thus is able to record images via said control means and said non-volatile memory storage means; and
a second camera,
wherein said second camera lens is in a hidden position proximal to the setting position for the enclosed gift, but is substantially unobfuscated from viewing the opening of said enclosure by the gift recipient, and
wherein said second camera is activated by said enclosure-opening sensing means, thus is able to record images via said control means and said non-volatile memory storage means;
selling said gift container to said consumer;
transferring recorded data from said gift container onto an external medium for said consumer's convenient access, after said consumer uses said gift container by:
preparing to present said gift to the gift recipient by activating said gift-transfer process detecting means, thus activating said first camera,
giving said gift to the gift recipient while said first camera records video or still pictures to document the gift recipient's reactions; and
opening said gift container by the gift recipient or by the gift giver, thereby activating said enclosure-opening means and in turn activating said second camera and recording video or still pictures to document the gift recipient's reactions as said enclosed gift is viewed unobstructed; and
removing recorded data from said gift container in preparation for the next gift-container use.

19. The method of claim 18, further comprising the step of providing a consumer with instruction on the use of said gift container.

20. The method of claim 18, wherein said external medium for said consumer's convenient access is selected from the group consisting of a portable USB memory drive, a compact disc, and removable flash memory card.

21. The method of claim 18, wherein said external medium for said consumer's convenient access is a website link to download video, images, and audio to said consumer's computing device.

22. A method for presenting a gift, comprising the steps of:
placing said gift inside a gift container, said gift container comprising:
an enclosure with a means to open said enclosure to display said enclosed gift,
wherein the volume and geometry in the top of said enclosure provides a substantial void around the enclosed gift to facilitate viewing of said gift and to facilitate minimal visual obstructions to camera viewing;
a control means for controlling signal and data-processing components;
a means for detecting the start of the gift-transfer process in order to send a signal to said control means to activate video-recording functionality;
a means for non-volatile memory storage;
a power supply for all camera and data-processing components within said gift container;
a means for communicating recorded data with an external computing device or video-display device;
a camera,
wherein said camera lens is located and angled in or on said enclosure for optimum video recording or optimum still-picture taking of the gift recipient, and is not obvious to a casual observer, and
wherein said camera is activated by said means for detecting the start of the gift-transfer process, thus is able to record images via said control means and said non-volatile memory storage means;
preparing to present said gift to the gift recipient by activating said means for detecting the start of the gift-transfer process, thus activating said camera; and
giving said gift to the gift recipient while said camera records video or still pictures to document the gift recipient's reactions.

23. The method of claim 22, wherein said gift container further comprises a means to record audio, said audio-recording means being activated simultaneously with the activation of said camera, and is thus able to record audio via said control means and said non-volatile memory storage.

24. The method of claim 23, further comprising the step of recording audio to document a gift recipient's reactions and the audio environment as the gift is viewed.

25. The method of claim 22, wherein said gift container's non-volatile memory storage is a removable flash memory card with an effective storage size for recording streaming video and audio.

26. The method of claim 25, wherein said effective storage size allows for recording up to 10 minutes of streaming video and audio.

27. The method of claim 25, wherein said gift container's a means for communicating recorded data with an external computing device or video-display device is to remove said flash memory card and install it into another computing device or video-display device for data reading and transfer.

28. The method of claim 22, wherein said gift container's a means for communicating recorded data with an external computing device or video-display device is a USB port.

29. The method of claim 22, wherein said gift container's a means for communicating recorded data with an external computing device or video-display device is a wireless data stream.

30. The method of claim 22, wherein said means for detecting the start of the gift-transfer process is a reed switch that detects the opening of said gift container that communicates an open signal to said control means.

31. The method of claim 22, wherein said means for detecting the start of the gift-transfer process is a button-actuator that is pressed to open said gift container and that communicates an open signal to said control means.

32. The method of claim 22, wherein said means for detecting the start of the gift-transfer process is a capacitance sensor located on at least one side of said gift container such that a signal to start said camera recording occurs when said gift container is contacted by a thumb or a finger.

33. The method of claim 22, wherein said means for detecting the start of the gift-transfer process is a motion sensor incorporated in said gift container.

34. A method for providing a consumer with the ability to present a gift while recording the gift-recipient's reactions, comprising the steps of:
obtaining or manufacturing a gift container, said gift container comprising:
an enclosure with a means to open said enclosure to display said enclosed gift,
wherein the volume and geometry in the top of said enclosure provides a substantial void around the enclosed gift to facilitate viewing of said gift and to facilitate minimal visual obstructions to camera viewing;
a control means for controlling signal and data-processing components;
a means for detecting the start of the gift-transfer process in order to send a signal to said control means to activate video-recording functionality;
a means for non-volatile memory storage;
a power supply for all camera and data-processing components within said gift container;
a means for communicating recorded data with an external computing device or video-display device;
a camera,
wherein said camera lens is located and angled in or on said enclosure for optimum video recording or optimum still-picture taking of the gift recipient, and is not obvious to a casual observer, and
wherein said camera is activated by said means for detecting the start of the gift-transfer process, thus is able to record images via said control means and said non-volatile memory storage means;
renting said gift container to said consumer;
recovering said gift container from said consumer, after said consumer uses said gift container by:
preparing to present said gift to the gift recipient by activating said means for detecting the start of the gift-transfer process, thus activating said camera,
giving said gift to the gift recipient while said camera records video or still pictures to document the gift recipient's reactions; and
transferring recorded data from said gift container onto an external medium for said consumer's convenient access; and
removing recorded data from said gift container in preparation for the next gift-container rental.

35. The method of claim 34, further comprising the step of providing a consumer with instruction on the use of said gift container.

36. The method of claim 34, wherein said external medium for said consumer's convenient access is selected from the group consisting of a portable USB memory drive, a compact disc, and removable flash memory card.

37. The method of claim 34, wherein said external medium for said consumer's convenient access is a website link to download video, images, and audio to said consumer's computing device.

38. A method for providing a consumer with the ability to present a gift while recording the gift-recipient's reactions, comprising the steps of:
obtaining or manufacturing a gift container, said gift container comprising:
an enclosure with a means to open said enclosure to display said enclosed gift,
wherein the volume and geometry in the top of said enclosure provides a substantial void around the enclosed gift to facilitate viewing of said gift and to facilitate minimal visual obstructions to camera viewing;
a control means for controlling signal and data-processing components;
a means for detecting the start of the gift-transfer process in order to send a signal to said control means to activate video-recording functionality;
a means for non-volatile memory storage;
a power supply for all camera and data-processing components within said gift container;
a means for communicating recorded data with an external computing device or video-display device;
a camera,
wherein said camera lens is located and angled in or on said enclosure for optimum video recording or optimum still-picture taking of the gift recipient, and is not obvious to a casual observer, and
wherein said camera is activated by said means for detecting the start of the gift-transfer process, thus is able to record images via said control means and said non-volatile memory storage means;
selling said gift container to said consumer;
transferring recorded data from said gift container onto an external medium for said consumer's convenient access, after said consumer uses said gift container by:
preparing to present said gift to the gift recipient by activating said means for detecting the start of the gift-transfer process, thus activating said camera,
giving said gift to the gift recipient while said camera records video or still pictures to document the gift recipient's reactions; and
removing recorded data from said gift container in preparation for the next gift-container use.

39. The method of claim 38, further comprising the step of providing a consumer with instruction on the use of said gift container.

40. The method of claim 38, wherein said external medium for said consumer's convenient access is selected from the group consisting of a portable USB memory drive, a compact disc, and removable flash memory card.

41. The method of claim 38, wherein said external medium for said consumer's convenient access is a website link to download video, images, and audio to said consumer's computing device.

42. A method for presenting a gift, comprising the steps of:
placing said gift inside a gift container, said gift container comprising:
an enclosure with a means to open said enclosure to display said enclosed gift,
wherein the volume and geometry in the top of said enclosure provides a substantial void around the enclosed gift to facilitate viewing of said gift and to facilitate minimal visual obstructions to camera viewing;
a control means for controlling signal and data-processing components;
a transmitter for communicating data with an external computing device or audio-video-recording device;
a means for detecting the start of the gift-transfer process in order to send a signal to said control means to activate audio-video-recording functionality;
an enclosure-opening sensing means,
wherein said enclosure-opening sensing means can be activated by either the gift giver or the gift recipient, and
wherein said enclosure-opening sensing means is communicatively coupled with said control means;
a power supply for all camera and related components within said gift container;
a first camera,
wherein said first camera lens is located in the top of said enclosure, is set such that said first camera lens' line of sight is substantially unobfuscated by other gift-container components and materials, is angled for optimum video recording or optimum still-picture taking of the gift recipient, and is not obvious to a casual observer, and
wherein said first camera is activated by said gift-transfer process detecting means, thus is able to record images via said control means and said transmitter to said external computing device or audio-video-recording device; and
a second camera,
wherein said second camera lens is in a hidden position proximal to the setting position for the enclosed gift, but is substantially unobfuscated from viewing the opening of said enclosure by the gift recipient, and
wherein said second camera is activated by said enclosure-opening sensing means, thus is able to record images via said control means and said external computing device or audio-video-recording device;
preparing to present said gift to the gift recipient by activating said gift-transfer process detecting means, thus activating said first camera;
giving said gift to the gift recipient while said first camera records video or still pictures to document the gift recipient's reactions; and
opening said gift container by the gift recipient or by the gift giver, thereby activating said enclosure-opening means and in turn activating said second camera and recording video or still pictures to document the gift recipient's reactions as said enclosed gift is viewed unobstructed.

43. The method of claim 42, wherein said gift container further comprises a means to record audio, said audio-recording means being activated simultaneously with the activation of said first camera by said gift-transfer process detecting means, and is thus able to record audio via said control means and said external computing device or audio-video-recording device.

44. The method of claim 43, further comprising the step of recording audio to document a gift recipient's reactions and the audio environment as the gift is viewed.

45. The method of claim 42, wherein said means for detecting the start of the gift-transfer process is a touch-enabled sensor on the outside of said enclosure,
wherein said touch-enabled sensor can be activated by either the gift giver or the gift recipient, and
wherein said touch-enabled sensor is communicatively coupled with said control means.

46. The method of claim 45, wherein said touch-enabled sensor is a capacitance sensor located on at least one side of said gift container such that a signal to start said first camera recording occurs when said gift container is contacted by a thumb or a finger.

47. The method of claim 45, wherein said touch-enabled sensor is disguised by an attractive overlay of wood, metal, or material, designed to match the aesthetics of the originally designed gift container.

48. The method of claim 42, wherein said means for detecting the start of the gift-transfer process is a motion sensor incorporated in said gift container.

49. A method for providing a consumer with the ability to present a gift while recording the gift-recipient's reactions, comprising the steps of:
obtaining or manufacturing a gift container, said gift container comprising:
an enclosure with a means to open said enclosure to display said enclosed gift,
wherein the volume and geometry in the top of said enclosure provides a substantial void around the enclosed gift to facilitate viewing of said gift and to facilitate minimal visual obstructions to camera viewing;
a control means for controlling signal and data-processing components;
a transmitter for communicating data with an external computing device or audio-video-recording device;
a means for detecting the start of the gift-transfer process in order to send a signal to said control means to activate audio-video-recording functionality;
an enclosure-opening sensing means,
wherein said enclosure-opening sensing means can be activated by either the gift giver or the gift recipient, and
wherein said enclosure-opening sensing means is communicatively coupled with said control means;
a power supply for all camera and related components within said gift container;
a first camera,
wherein said first camera lens is located in the top of said enclosure, is set such that said first camera lens' line of sight is substantially unobfuscated by other gift-container components and materials, is angled for optimum video recording or optimum still-picture taking of the gift recipient, and is not obvious to a casual observer, and
wherein said first camera is activated by said gift-transfer process detecting means, thus is able to record images via said control means and said transmitter to said external computing device or audio-video-recording device; and
a second camera,
wherein said second camera lens is in a hidden position proximal to the setting position for the enclosed gift, but is substantially unobfuscated from viewing the opening of said enclosure by the gift recipient, and
wherein said second camera is activated by said enclosure-opening sensing means, thus is able to record images via said control means and said external computing device or audio-video-recording device;
renting said gift container to said consumer;
renting external computing device or audio-video-recording device to said consumer;
transferring recorded data from said external computing device or audio-video-recording device onto an external medium for said consumer's convenient access;
recovering said gift container and said external computing device or audio-video-recording device from said consumer, after said consumer uses said gift container by:
preparing to present said gift to the gift recipient by activating said gift-transfer process detecting means, thus activating said first camera;
giving said gift to the gift recipient while said first camera records video or still pictures to document the gift recipient's reactions; and
opening said gift container by the gift recipient or by the gift giver, thereby activating said enclosure-opening means and in turn activating said second camera and recording video or still pictures to document the gift recipient's reactions as said enclosed gift is viewed unobstructed; and
removing recorded data from said external computing device or audio-video-recording device in preparation for the next gift-container rental.

50. The method of claim 49, further comprising the step of providing a consumer with instruction on the use of said gift container.

51. The method of claim 49, wherein said external medium for said consumer's convenient access is selected from the group consisting of a portable USB memory drive, a compact disc, and removable flash memory card.

52. The method of claim 49, wherein said external medium for said consumer's convenient access is a website link to download video, images, and audio to said consumer's computing device.

53. A method for providing a consumer with the ability to present a gift while recording the gift-recipient's reactions, comprising the steps of:
obtaining or manufacturing a gift container, said gift container comprising:
an enclosure with a means to open said enclosure to display said enclosed gift,
wherein the volume and geometry in the top of said enclosure provides a substantial void around the enclosed gift to facilitate viewing of said gift and to facilitate minimal visual obstructions to camera viewing;
a control means for controlling signal and data-processing components;
a transmitter for communicating data with an external computing device or audio-video-recording device;
a means for detecting the start of the gift-transfer process in order to send a signal to said control means to activate audio-video-recording functionality;
an enclosure-opening sensing means,
wherein said enclosure-opening sensing means can be activated by either the gift giver or the gift recipient, and
wherein said enclosure-opening sensing means is communicatively coupled with said control means;
a power supply for all camera and related components within said gift container;
a first camera,
wherein said first camera lens is located in the top of said enclosure, is set such that said first camera lens' line of sight is substantially unobfuscated by other gift-container components and materials, is angled for optimum video recording or optimum still-picture taking of the gift recipient, and is not obvious to a casual observer, and
wherein said first camera is activated by said gift-transfer process detecting means, thus is able to record images via said control means and said transmitter to said external computing device or audio-video-recording device; and
a second camera,
wherein said second camera lens is in a hidden position proximal to the setting position for the enclosed gift, but is substantially unobfuscated from viewing the opening of said enclosure by the gift recipient, and
wherein said second camera is activated by said enclosure-opening sensing means, thus is able to record images via said control means and said external computing device or audio-video-recording device;
selling said gift container to said consumer;
selling external computing device or audio-video-recording device to said consumer;
transferring recorded data from said gift container onto an external medium for said consumer's convenient access, after said consumer uses said gift container by:
preparing to present said gift to the gift recipient by activating said gift-transfer process detecting means, thus activating said first camera;
giving said gift to the gift recipient while said first camera records video or still pictures to document the gift recipient's reactions; and
opening said gift container by the gift recipient or by the gift giver, thereby activating said enclosure-opening means and in turn activating said second camera and recording video or still pictures to document the gift recipient's reactions as said enclosed gift is viewed unobstructed; and
removing recorded data from said gift container in preparation for the next gift-container use.

54. The method of claim 53, further comprising the step of providing a consumer with instruction on the use of said gift container.

55. The method of claim 53, wherein said external medium for said consumer's convenient access is selected from the group consisting of a portable USB memory drive, a compact disc, and removable flash memory card.

56. The method of claim 53, wherein said external medium for said consumer's convenient access is a website link to download video, images, and audio to said consumer's computing device.

57. A method for presenting a gift, comprising the steps of:
placing said gift inside a gift container, said gift container comprising:
an enclosure with a means to open said enclosure to display said enclosed gift,
wherein the volume and geometry in the top of said enclosure provides a substantial void around the enclosed gift to facilitate viewing of said gift and to facilitate minimal visual obstructions to camera viewing;
a control means for controlling signal and data-processing components;
a transmitter for communicating data with an external computing device or audio-video-recording device;
a means for detecting the start of the gift-transfer process in order to send a signal to said control means to activate video-recording functionality;
a power supply for all camera and data-processing components within said gift container;
a camera,
wherein said camera lens is located and angled in or on said enclosure for optimum video recording or optimum still-picture taking of the gift recipient, and is not obvious to a casual observer, and
wherein said camera is activated by said means for detecting the start of the gift-transfer process, thus is able to record images via said control means and said external computing device or audio-video-recording device;
preparing to present said gift to the gift recipient by activating said means for detecting the start of the gift-transfer process, thus activating said camera; and
giving said gift to the gift recipient while said camera records video or still pictures to document the gift recipient's reactions.

58. The method of claim 57, wherein said gift container further comprises a means to record audio, said audio-recording means being activated simultaneously with the activation of said camera, and is thus able to record audio via said control means and said external computing device or audio-video-recording device.

59. The method of claim 58, further comprising the step of recording audio to document a gift recipient's reactions and the audio environment as the gift is viewed.

60. The method of claim 57, wherein said means for detecting the start of the gift-transfer process is a reed switch that detects the opening of said gift container that communicates an open signal to said control means.

61. The method of claim 57, wherein said means for detecting the start of the gift-transfer process is a button-actuator that is pressed to open said gift container and that communicates an open signal to said control means.

62. The method of claim 57, wherein said means for detecting the start of the gift-transfer process is a capacitance sensor located on at least one side of said gift container such that a signal to start said camera recording occurs when said gift container is contacted by a thumb or a finger.

63. The method of claim 57, wherein said means for detecting the start of the gift-transfer process is a motion sensor incorporated in said gift container.

64. A method for providing a consumer with the ability to present a gift while recording the gift-recipient's reactions, comprising the steps of:
obtaining or manufacturing a gift container, said gift container comprising:
an enclosure with a means to open said enclosure to display said enclosed gift,
wherein the volume and geometry in the top of said enclosure provides a substantial void around the enclosed gift to facilitate viewing of said gift and to facilitate minimal visual obstructions to camera viewing;
a control means for controlling signal and data-processing components;
a transmitter for communicating data with an external computing device or audio-video-recording device;
a means for detecting the start of the gift-transfer process in order to send a signal to said control means to activate video-recording functionality;
a power supply for all camera and data-processing components within said gift container;
a camera,
wherein said camera lens is located and angled in or on said enclosure for optimum video recording or optimum still-picture taking of the gift recipient, and is not obvious to a casual observer, and
wherein said camera is activated by said means for detecting the start of the gift-transfer process, thus is able to record images via said control means and said external computing device or audio-video-recording device;
renting said gift container to said consumer;
renting external computing device or audio-video-recording device to said consumer;
transferring recorded data from said external computing device or audio-video-recording device onto an external medium for said consumer's convenient access;
recovering said gift container and said external computing device or audio-video-recording device from said consumer, after said consumer uses said gift container by:
preparing to present said gift to the gift recipient by activating said means for detecting the start of the gift-transfer process, thus activating said camera; and
giving said gift to the gift recipient while said camera records video or still pictures to document the gift recipient's reactions; and
removing recorded data from said external computing device or audio-video-recording device in preparation for the next gift-container rental.

65. The method of claim 64, further comprising the step of providing a consumer with instruction on the use of said gift container.

66. The method of claim 64, wherein said external medium for said consumer's convenient access is selected from the group consisting of a portable USB memory drive, a compact disc, and removable flash memory card.

67. The method of claim 64, wherein said external medium for said consumer's convenient access is a website link to download video, images, and audio to said consumer's computing device.

68. A method for providing a consumer with the ability to present a gift while recording the gift-recipient's reactions, comprising the steps of:
obtaining or manufacturing a gift container, said gift container comprising:
an enclosure with a means to open said enclosure to display said enclosed gift,
wherein the volume and geometry in the top of said enclosure provides a substantial void around the enclosed gift to facilitate viewing of said gift and to facilitate minimal visual obstructions to camera viewing;
a control means for controlling signal and data-processing components;
a transmitter for communicating data with an external computing device or audio-video-recording device;
a means for detecting the start of the gift-transfer process in order to send a signal to said control means to activate video-recording functionality;
a power supply for all camera and data-processing components within said gift container;
a camera,
wherein said camera lens is located and angled in or on said enclosure for optimum video recording or optimum still-picture taking of the gift recipient, and is not obvious to a casual observer, and
wherein said camera is activated by said means for detecting the start of the gift-transfer process, thus is able to record images via said control means and said external computing device or audio-video-recording device;
selling said gift container to said consumer;
selling external computing device or audio-video-recording device to said consumer; transferring recorded data from said gift container onto an external medium for said consumer's convenient access, after said consumer uses said gift container by:
preparing to present said gift to the gift recipient by activating said means for detecting the start of the gift-transfer process, thus activating said camera; and
giving said gift to the gift recipient while said camera records video or still pictures to document the gift recipient's reactions; and
removing recorded data from said gift container in preparation for the next gift-container use.

69. The method of claim 68, further comprising the step of providing a consumer with instruction on the use of said gift container.

70. The method of claim 68, wherein said external medium for said consumer's convenient access is selected from the group consisting of a portable USB memory drive, a compact disc, and removable flash memory card.

71. The method of claim 68, wherein said external medium for said consumer's convenient access is a website link to download video, images, and audio to said consumer's computing device.
